(19) United States
(12) Patent Application Publication
(10) Pub. No.: US 2022/0270799 A1
(43) Pub. Date: Aug. 25, 2022

(54) DRIVING DEVICE AND METHOD USING TEMPERATURE MEASUREMENT AND DUAL-GAS-SOURCE VALVE CONTROL SYSTEM

(71) Applicant: Chant Heat Energy Science & Technology (Zhongshan) Co., LTD., Zhongshan (CN)

(72) Inventors: Guoquan Chen, Zhongshan (CN); Licheng Xie, Zhongshan (CN); Xianmin Deng, Zhongshan (CN); Jintang You, Zhongshan (CN); Guangzhi Mai, Zhongshan (CN)

(73) Assignee: Chant Heat Energy Science & Technology (Zhongshan) Co., LTD., Zhongshan (CN)

(21) Appl. No.: 16/982,766

(22) PCT Filed: Aug. 21, 2020
(86) PCT No.: PCT/CN2020/110569

§ 371 Date: Sep. 21, 2020

(30) Foreign Application Priority Data
Jul. 28, 2020 (CN) 202010738705.9

(51) Int. Cl. H01F 7/06; H01F 7/08; F16K 31/02; F16K 31/06; F23N 1/00

(52) U.S. Cl. CPC H01F 7/064; H01F 7/081; F16K 31/025; F16K 31/0679; F23N 1/007; F23N 2235/22; F23D 23/00

(57) ABSTRACT

A driving device using temperature measurement, a driving method using temperature measurement and a dual-gas-source valve control system, wherein the device includes at least two thermocouple components; and a magnetic-drive assembly, wherein each thermocouple component is connected with the magnetic-drive assembly, the thermocouple components are capable of driving the magnetic-drive assembly to generate a magnetic flux according to an external temperature, and some of the thermocouple components drive the magnetic-drive assembly to generate a magnetic flux that is capable of being offset with a magnetic flux generated by the magnetic-drive assembly driven by the other of the thermocouple components.

### PRIORITY

This application is a national stage filing, under 35 U.S.C. § 371, of International application number PCT/CN2020/110569, filed Aug. 21, 2020, which claims priority to Chinese patent application No. 2020107387059, filed Jul. 28, 2020. This application claims priority under 35 U.S.C. § 119 to Chinese patent application No. 2020107387059, filed Jul. 28, 2020. The entire content of International application number PCT/CN2020/110569, filed Aug. 21, 2020, is incorporated by reference. The entire content of Chinese patent application No. 2020107387059, filed Jul. 28, 2020, is incorporated by reference.

### FIELD

The disclosure relates to the field of temperature detection and control, and more particularly, to a driving device using temperature measurement, a driving method using temperature measurement and a dual-gas-source valve control system.

### BACKGROUND

For a traditional mode in which a thermocouple is used for controlling operation of a valve body, generally, one thermocouple is matched with one valve body, the thermocouple detects an external temperature, and is capable of generating a potential difference according to a working principle of the thermocouple. An output potential difference is capable of driving the valve body to open and close, and then the valve body controls operation of an external pipeline.

When two sets of different temperature conditions need to be detected, and the operation of the external pipeline is jointly controlled according to results of the two sets of temperature conditions, two sets of the above structures that one thermocouple is matched with one valve body generally need to be used, and then a corresponding logic can be realized through cooperation of a relatively complicated pipeline topology structure, resulting in complicated production and high cost.

### SUMMARY

The disclosure is intended to solve at least one of the technical problems in the prior art. Therefore, the disclosure provides a driving device using temperature measurement, which is simple in structure and strong in compatibility.

The disclosure further provides a driving method using temperature measurement, which is convenient to be used by a user and is compatible with various temperature measurement logic controls.

The disclosure further provides a dual-gas-source valve control system, which is simple in structure and capable of controlling operation of a gas valve according to ignition conditions of dual gas sources, thus being safe and reliable.

A driving device using temperature measurement according to the embodiment of the first aspect of the disclosure includes: at least two thermocouple components; and a magnetic-drive assembly, wherein each thermocouple component is connected with the magnetic-drive assembly, the thermocouple components are capable of driving the magnetic-drive assembly to generate a magnetic flux according to an external temperature, and some of the thermocouple components drive the magnetic-drive assembly to generate a magnetic flux that is capable of being offset with a magnetic flux generated by the magnetic-drive assembly driven by the other of the thermocouple components.

The driving device using temperature measurement according to the embodiment of the disclosure has at least the following beneficial effects.

In the driving device using temperature measurement of the disclosure, different thermocouple components can be used for detecting temperatures of different objects or environments, and the thermocouple components drive the magnetic-drive assembly to generate the magnetic flux according to the external temperature. Since temperatures of environments where different thermocouple components are located are different, potentials generated by the thermocouple components are different. Therefore, the magnetic fluxes generated by the magnetic-drive assembly driven by different thermocouple components are different, and can be partially or wholly offset with each other. The magnetic fluxes in the magnetic-drive assembly may be present as a magnetic force after being partially or wholly offset, thus achieving driving effects of different degrees. According to the design, multiple temperature states may be detected respectively by multiple thermocouple components, then the amount of the magnetic flux generated by the magnetic-drive assembly driven by each thermocouple component may be integrated, so as to be finally converted into a magnetic force by the magnetic-drive assembly. The device is simple in structure, strong in compatibility with various temperature measurement logic controls.

According to some embodiments of the disclosure, the magnetic-drive assembly includes a base shell, a magnetic core arranged on the base shell and a movable member movably arranged on the base shell, the movable member is attractable by a magnetic force generated by the magnetic core, electromagnetic coils matched with the thermocouple components one by one are wound on the magnetic core, and the thermocouple components are connected with the electromagnetic coils.

According to some embodiments of the disclosure, the magnetic-drive assembly further includes a reset member arranged on the base shell, and the reset member is connected with the movable member so as to drive the movable member to reset.

According to some embodiments of the disclosure, a conductive member is arranged on the base shell, and the thermocouple components are connected with the electromagnetic coils through the conductive member.

According to some embodiments of the disclosure, the conductive member is a conductive pedestal, the conductive pedestal is connected with the base shell to form an accommodating cavity capable of accommodating the magnetic-drive assembly, the conductive pedestal is provided with at least one through hole allowing a wire to penetrate through, one pole of the thermocouple component is connected with one end of the electromagnetic coil through the wire, the other pole of the thermocouple component is connected with the conductive pedestal, and the other end of the electromagnetic coil is connected with the conductive pedestal.

According to some embodiments of the disclosure, the magnetic core includes at least two magnetic columns, one end of each magnetic column is connected with each other, the other end of each magnetic column faces towards the movable member, and the electromagnetic coils are wound on the magnetic columns.

A driving method using temperature measurement according to the embodiment of the second aspect of the disclosure is realized based on the driving device using temperature measurement disclosed by any one of the above embodiments, and includes the following steps: driving, by the thermocouple components, the magnetic-drive assembly to generate magnetic fluxes according to external temperatures, and driving the magnetic-drive assembly to operate according to integration of the magnetic fluxes generated by the magnetic-drive assembly driven by all the thermocouple components.

A dual-gas-source valve control system according the embodiment of the third aspect of the disclosure includes: a first gas assembly connected with a first external gas source and capable of igniting the first gas source; a second gas assembly connected with a second external gas source and capable of igniting the second gas source; a first thermocouple component and a second thermocouple component both used for detecting ignition conditions of the first gas assembly and the second gas assembly in different degrees; and a magnetic-drive assembly, wherein the first thermocouple component and the second thermocouple component are both connected with the magnetic-drive assembly, and the first thermocouple component and the second thermocouple component are both capable of driving the magnetic-drive assembly to generate a magnetic flux according to an external temperature; a magnetic flux generated by the magnetic-drive assembly driven by the first thermocouple component is capable of being offset with a magnetic flux generated by the magnetic-drive assembly driven by the second thermocouple component, the magnetic-drive assembly is driven to operate according to integration of the magnetic fluxes generated by the magnetic-drive assembly driven by the first thermocouple component and the second thermocouple component, and the operation of the magnetic-drive assembly is capable of controlling delivery of gas in the first gas assembly and the second gas assembly.

The dual-gas-source valve control system according to the embodiment of the disclosure has at least the following beneficial effects.

In the dual-gas-source valve control system of the disclosure, the first thermocouple component and the second thermocouple component respectively detect ignition conditions of the first gas assembly and the second gas assembly in different degrees, the dual-gas-source valve control system is compatible with temperature measurement control logics in various conditions, thus controlling delivery of a first gas source and a second gas source by controlling the operation of the magnetic-drive assembly, and when conditions such as abnormal ignition and misconnection of the gas sources occur, the delivery of the first gas source and the second gas source is limited in time, thus increasing a use safety level.

According to some embodiments of the disclosure, the first thermocouple component and the second thermocouple component are located between an ignition end of the first gas assembly and an ignition end of the second gas assembly, the first thermocouple component is closer to the ignition end of the first gas assembly than the second thermocouple component, and the second thermocouple component is closer to the ignition end of the second gas assembly than the first thermocouple component.

The additional aspects and advantages of the disclosure will be partially provided in the following description, and will partially be apparent in the following description, or learned by practice of the disclosure.

### BRIEF DESCRIPTION OF THE DRAWINGS

The above and/or additional aspects and advantages of the disclosure will be apparent and easily understood from the description of the embodiments with reference to the following accompanying drawings, wherein:

FIG. 1 is a structure diagram of a first embodiment of a driving device using temperature measurement according to the disclosure;

FIG. 2 is a structure diagram of a second embodiment of the driving device using temperature measurement according to the disclosure;

FIG. 3 is a structure diagram of a third embodiment of the driving device using temperature measurement according to the disclosure;

FIG. 4 is a structure diagram of a dual-gas-source valve control system in a standby state according to the disclosure;

FIG. 5 is a structure diagram of a first gas assembly of the dual-gas-source valve control system in a normal ignition state according to the disclosure;

FIG. 6 is a structure diagram of the first gas assembly of the dual-gas-source valve control system in a misconnection ignition state according to the disclosure;

FIG. 7 is a structure diagram of a second gas assembly of the dual-gas-source valve control system in a normal ignition state according to the disclosure; and

FIG. 8 is a structure diagram of the second gas assembly of the dual-gas-source valve control system in a misconnection ignition state according to the disclosure.

### REFERENCE NUMERALS

100 refers to first thermocouple component, 200 refers to second thermocouple component, 300 refers to magnetic-drive assembly, 310 refers to base shell, 320 refers to magnetic core, 321 refers to first magnetic column, 322 refers to second magnetic column, 330 refers to first electromagnetic coil, 340 refers to second electromagnetic coil, 350 refers to movable member, 360 refers to reset member, 400 refers to conductive member, 500 refers to liquefied gas nozzle, and 600 refers to natural gas nozzle.

### DETAILED DESCRIPTION OF THE EMBODIMENTS

Reference will now be made in detail to the embodiments of the present invention, examples of which are illustrated in the accompanying drawings, wherein like reference numerals refer to the same or similar elements or elements having the same or similar functions throughout. The embodiments described below with reference to the accompanying drawings are illustrative only for the purpose of explaining the disclosure and are not to be construed as limiting the disclosure.

In the description of the disclosure, it should be understood that the orientation or position relationship indicated by the terms “up”, “down”, “front”, “rear”, “left”, “right”, “vertical”, “horizontal”, “top”, “bottom”, “inside”, “outside”, and the like is based on the orientation or position relationship shown in the accompanying drawings, it is only for the convenience of description of the disclosure and simplification of the description, and it is not to indicate or imply that the indicated device or element must have a specific orientation, and be constructed and operated in a specific orientation. Therefore, the terms should not be understood as limiting the disclosure.

In the description of the disclosure, “certain” means one or more, “a plurality of” means two or more, and “greater than”, “less than”, “more than”, etc. are understood as excluding the number itself, “above”, “below”, “within”, etc. are understood as including the number itself. “First”, “second”, etc., if referred to, are for the purpose of distinguishing technical features only, cannot be understood as indicating or implying a relative importance or implicitly indicating the number of technical features indicated or implicitly indicating the precedence of technical features indicated.

In the description of the disclosure, it should be noted that the terms “installation”, “connected” and “connection” if any should be understood in a broad sense unless otherwise specified and defined. For example, they may be fixed connection, removable connection or integrated connection; may be mechanical connection or electrical connection; and may be direct connection, or indirect connection through an intermediate medium, and connection inside two elements. The specific meanings of the above terms in the disclosure may be understood in a specific case by those of ordinary skills in the art.

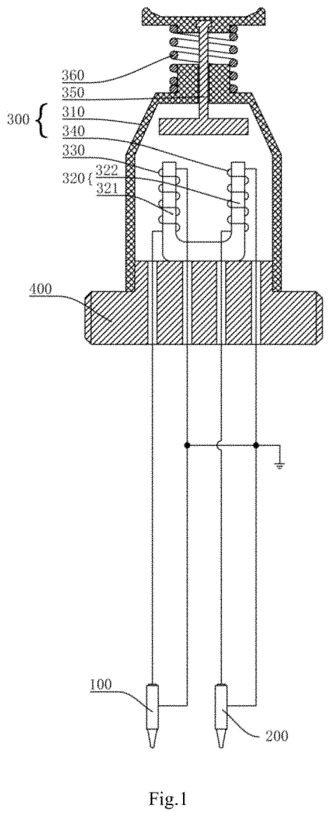

As shown in FIG. 1 to FIG. 3, a driving device using temperature measurement according to embodiments of the disclosure includes at least two thermocouple components and a magnetic-drive assembly 300. Each thermocouple component is connected with the magnetic-drive assembly 300, the thermocouple components are capable of driving the magnetic-drive assembly 300 to generate a magnetic flux according to an external temperature, and some of thermocouple components drive the magnetic-drive assembly 300 to generate a magnetic flux, which is capable of being offset with a magnetic flux generated by the magnetic-drive assembly 300 driven by other thermocouple components.

It should be noted that temperature measurement elements commonly used in the thermocouple components are used for measuring a temperature and converting a temperature signal into a thermoelectromotive force signal. Both ends of two conductors with different components (referred to as thermocouple wires or thermodes) are connected to form a loop. When temperatures of the two conductors are different, an electromotive force is generated in the loop. Moreover, the magnetic-drive assembly 300 is coupled with the loop of the thermocouple components, and the electromotive force in the loop may cause the magnetic-drive assembly 300 to generate the magnetic fluxes. Multiple thermocouple components are coupled with the magnetic-drive assembly 300 in different access modes or different electromotive force directions, so that the magnetic fluxes are generated in different directions, and the magnetic fluxes in different directions may be offset.

In the driving device using temperature measurement of the disclosure, different thermocouple components can be used for detecting temperatures of different objects or environments, and the thermocouple components drive the magnetic-drive assembly 300 to generate the magnetic flux according to the external temperature. Since temperatures of environments where different thermocouple components are located are different, potentials generated by the thermocouple components are different. Therefore, the magnetic fluxes generated by the magnetic-drive assembly 300 driven by different thermocouple components are different, and can be partially or wholly offset with each other. The magnetic fluxes in the magnetic-drive assembly 300 may be present as a magnetic force after being partially or wholly offset, thus achieving driving effects of different degrees. According to the design, multiple temperature states may be detected respectively by multiple thermocouple components, then the amount of the magnetic flux generated by the magnetic-drive assembly 300 driven by each thermocouple component may be integrated, so as to be finally converted into a magnetic force by the magnetic-drive assembly 300. The device is simple in structure, strong in compatibility with various temperature measurement logic controls.

In some embodiments of the disclosure, the magnetic-drive assembly 300 includes a base shell 310, a magnetic core 320 arranged on the base shell 310 and a movable member 350 movably arranged on the base shell 310, the movable member 350 is attractable by a magnetic force generated by the magnetic core 320, electromagnetic coils matched with the thermocouple components one by one are wound on the magnetic core 320, and the thermocouple components are connected with the electromagnetic coils.

In some embodiments of the disclosure, the magnetic-drive assembly 300 further includes a reset member 360 arranged on the base shell 310, and the reset member 360 is connected with the movable member 350 so as to drive the movable member 350 to reset. The reset member 360 herein may be a spring or a counterweight.

In some cases, the magnetic core 320 generates a magnetic force, and when the magnetic force is large enough, the far-away movable member 350 can be attracted to the magnetic core 320. Alternatively, when the magnetic core 320 generates the magnetic force, a user may press the movable member 350 onto the magnetic core 320, and the magnetic core 320 attracts the movable member 350 to maintain this state. When the magnetic flux is reduced, and the magnetic force is weakened to be not large enough to attract the movable member 350, the movable member 350 will be reset by the reset member 360.

It should be noted herein that the movable member 350 can be reset without the need for different thermocouple components to drive the magnetic drive assembly 300 to produce magnetic fluxes that are completely offset. As long as the thermocouple components detect the external temperature, and a temperature difference exists between the two conductors, the electromotive force may be generated, and the magnetic-drive assembly 300 is driven to generate magnetic fluxes. Moreover, when an absolute value of a sum of all the magnetic fluxes generated by the driven magnetic-drive assembly 300 is large enough, the magnetic force generated on the movable member 350 can also be increased, thus being capable of attracting the movable member 350, while when the absolute value of the sum of the magnetic fluxes generated by the magnetic-drive assembly 300 is reduced to a certain extent, the magnetic force generated on the movable member 350 is not large enough to maintain attraction, and then the movable member 350 is reset by the reset member 360. In some embodiments, a specification of the selected thermocouple components shows a parameter characteristic that when the thermocouple components are heated, a potential difference of 1.5 mV to 0 V may be generated.

In some embodiments of the disclosure, the magnetic core 320 includes at least two magnetic columns, one end of each magnetic column is connected with each other, the other end of each magnetic column faces towards the movable member 350, and the electromagnetic coils are wound on the magnetic columns.

Different magnetic columns are matched with the thermocouple components one by one herein, thus reducing interference. Meanwhile, the thermocouple components can also be coupled to realize integration and offset of the magnetic fluxes.

In some embodiments of the disclosure, a conductive member 400 is arranged on the base shell 310, and the thermocouple components are connected with the electromagnetic coils through the conductive member 400.

Specifically, the conductive member 400 is a conductive pedestal, the conductive pedestal is connected with the base shell 310 to form an accommodating cavity capable of accommodating the magnetic-drive assembly 300, the conductive pedestal is provided with at least one through hole allowing a wire to penetrate through, one pole of the thermocouple component is connected with one end of the electromagnetic coil through the wire, the other pole of the thermocouple component is connected with the conductive pedestal, and the other end of the electromagnetic coil is connected with the conductive pedestal.

Specifically, as shown in FIG. 1 to FIG. 3, two thermocouple components are provided, which are respectively a first thermocouple component 100 and a second thermocouple component 200. Two electromagnetic coils are provided, which are respectively a first electromagnetic coil 330 and a second electromagnetic coil 340. Two magnetic columns are also provided, which are respectively a first magnetic column 321 and a second magnetic column 322, and bottom ends of the first magnetic column 321 and the second magnetic column 322 are connected. The first electromagnetic coil 330 and the second electromagnetic coil 340 are wound on the first magnetic column 321 and the second magnetic column 322 in a same winding mode.

As shown in FIG. 1, as the first embodiment, the pedestal is provided with four through holes. A positive pole of the first thermocouple component 100 penetrates through the through hole by a wire, and is connected with a lower end of the first electromagnetic coil 330. A negative pole of the first thermocouple component 100 penetrates through the through hole by a wire, and is connected with an upper end of the first electromagnetic coil 330. A positive pole of the second thermocouple component 200 penetrates through the through hole by a wire, and is connected with a lower end of the second electromagnetic coil 340. A negative pole of the second thermocouple component 200 penetrates through the through hole by a wire, and is connected with an upper end of the second electromagnetic coil 340. The negative pole of the first thermocouple component 100 and the negative pole of the second thermocouple component 200 are both grounded.

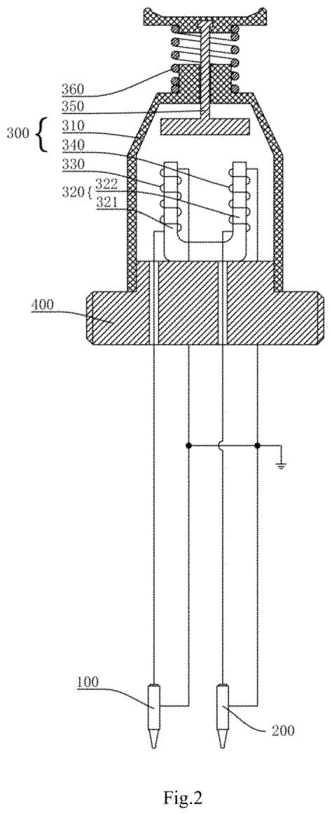

As shown in FIG. 2, as the second embodiment, the conductive pedestal is provided with two through holes. The positive pole of the first thermocouple component 100 penetrates through the through hole by the wire, and is connected with the lower end of the first electromagnetic coil 330. The negative pole of the first thermocouple component 100 is connected with the conductive pedestal. The upper end of the first electromagnetic coil 330 is connected with the conductive pedestal. The positive pole of the second thermocouple component 200 penetrates through the through hole by the wire, and is connected with the lower end of the second electromagnetic coil 340. The negative pole of the second thermocouple component 200 is connected with the conductive pedestal. The upper end of the second electromagnetic coil 340 is connected with the conductive pedestal. The negative pole of the first thermocouple component 100 and the negative pole of the second thermocouple component 200 are both grounded.

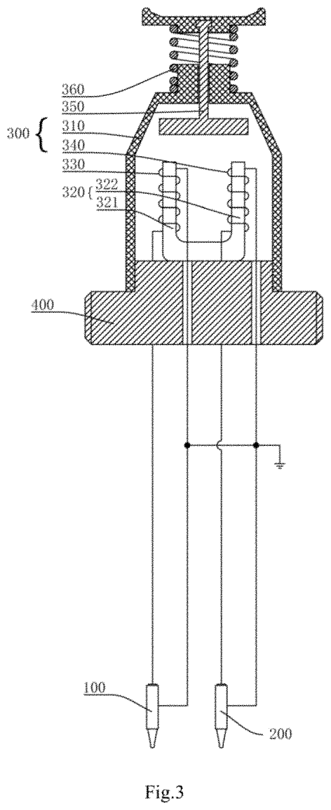

Alternatively, as shown in FIG. 3, as the second embodiment, the pedestal is provided with two through holes. The negative pole of the first thermocouple component 100 penetrates through the through hole by the wire, and is connected with the upper end of the first electromagnetic coil 330. The positive pole of the first thermocouple component 100 is connected with the conductive pedestal. The lower end of the first electromagnetic coil 330 is connected with the conductive pedestal. The negative pole of the second thermocouple component 200 penetrates through the through hole by the wire, and is connected with the upper end of the second electromagnetic coil 340. The positive pole of the second thermocouple component 200 is connected with the conductive pedestal. The lower end of the second electromagnetic coil 340 is connected with the conductive pedestal. The negative pole of the first thermocouple component 100 and the negative pole of the second thermocouple component 200 are both grounded.

A driving method using temperature measurement according to embodiments of the second aspect of the disclosure is realized based on the driving device using temperature measurement disclosed by any one of the above embodiments, and includes the following steps: driving, by the thermocouple components, the magnetic-drive assembly 300 to generate magnetic fluxes according to the external temperatures, and driving the magnetic-drive assembly 300 to operate according to integration of the magnetic fluxes generated by the magnetic-drive assembly 300 driven by all the thermocouple components.

The driving method using temperature measurement according to the design is convenient to be used by a user and is compatible with various temperature measurement logic controls.

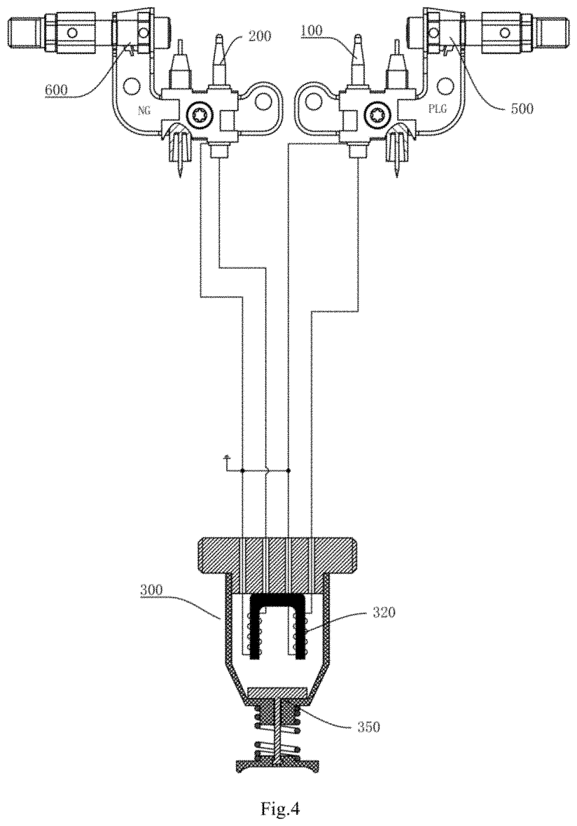

As shown in FIG. 4 to FIG. 8, a dual-gas-source valve control system according embodiments of the third aspect of the disclosure includes: a first gas assembly, a second gas assembly, a first thermocouple component 100, a second thermocouple component 200 and a magnetic-drive assembly 300. The first gas assembly is connected with a first external gas source and capable of igniting the first gas source. The second gas assembly is connected with a second external gas source and capable of igniting the second gas source. The first thermocouple component 100 and the second thermocouple component 200 are both used for detecting ignition conditions of the first gas assembly and the second gas assembly in different degrees. The first thermocouple component 100 and the second thermocouple component 200 are both connected with the magnetic-drive assembly 300. The first thermocouple component 100 and the second thermocouple component 200 both can drive the magnetic-drive assembly 300 to generate a magnetic flux according to an external temperature. Moreover, the magnetic flux generated by the magnetic-drive assembly 300 driven by the first thermocouple component 100 can be offset with the magnetic flux generated by the magnetic-drive assembly 300 driven by the second thermocouple component 200. The magnetic-drive assembly 300 is driven to operate according to integration of the magnetic fluxes generated by the magnetic-drive assembly 300 driven by the first thermocouple component 100 and the second thermocouple component 200, and the operation of the magnetic-drive assembly 300 can control delivery of gas in the first gas assembly and the second gas assembly.

In the dual-gas-source valve control system of the disclosure, the first thermocouple component 100 and the second thermocouple component 200 respectively detect ignition conditions of the first gas assembly and the second gas assembly in different degrees, the dual-gas-source valve control system is compatible with temperature measurement control logics in various conditions, thus controlling delivery of a first gas source and a second gas source by controlling the operation of the magnetic-drive assembly 300, and when conditions such as abnormal ignition and misconnection of the gas sources occur, the delivery of the first gas source and the second gas source is limited in time, thus increasing a use safety level.

In some embodiments of the disclosure, as shown in FIG. 4 to FIG. 8, the first thermocouple component 100 and the second thermocouple component 200 are located between an ignition end of the first gas assembly and an ignition end of the second gas assembly, the first thermocouple component 100 is closer to the ignition end of the first gas assembly than the second thermocouple component 200, and the second thermocouple component 200 is closer to the ignition end of the second gas assembly than the first thermocouple component 100.

Specifically, in some embodiments of the disclosure, the first gas assembly includes a liquefied gas nozzle 500, and the second gas assembly includes a natural gas nozzle 600 (gas outlets of the liquefied gas nozzle 500 and the natural gas nozzle 600 are both provided with an ignition needle). The magnetic-drive assembly 300 may be a part of an electromagnetic valve, and when the movable member 350 of the magnetic-drive assembly 300 is pressed, the electromagnetic valve can be controlled to be opened. The external natural gas source or liquefied gas source can supply gas to the liquefied gas nozzle 500 or the natural gas nozzle 600 through the electromagnetic valve. It should be noted that the electromagnetic valve herein may be an integrated and combined valve body, and the natural gas source and the liquefied gas source may be connected with the electromagnetic valve respectively, and then led into the liquefied gas nozzle 500 and the natural gas nozzle 600 respectively by the electromagnetic valve. Alternatively, the electromagnetic valve may be composed of two independent valve bodies, which are both driven by the magnetic-drive assembly 300 or can be linked with the movable member 350 of the magnetic-drive assembly 300.

Moreover, in the embodiment of FIG. 4 to FIG. 8, the first thermocouple component 100 and the second thermocouple component 200 used herein have a parameter characteristic that, under normal ignition, when the first thermocouple component 100 and the second thermocouple component 200 are heated to a certain degree, a potential difference of 1.5 mV to 0 V may be generated, and the potential difference may not be generated when the first thermocouple component and the second thermocouple component are only close to a fire source, and the temperature is not high enough.

When the movable member 350 is pressed and the magnetic core 320 can attract the movable member 350, the electromagnetic valve can be kept open to supply gas to the liquefied gas nozzle 500 or the natural gas nozzle 600. When the magnetic core 320 cannot attract the movable member 350 and the movable member 350 is reset, the electromagnetic valve is closed to stop supplying gas to the liquefied gas nozzle 500 or the natural gas nozzle 600, and the liquefied gas nozzle 500 or the natural gas nozzle 600 will fire off.

A specific control flow is as follows: as shown in FIG. 4, the dual-gas-source valve control system is in a standby state at the moment, the movable member 350 is not pressed, the liquefied gas nozzle 500 and the natural gas nozzle 600 are not ignited, and the electromagnetic valve is in a closed state.

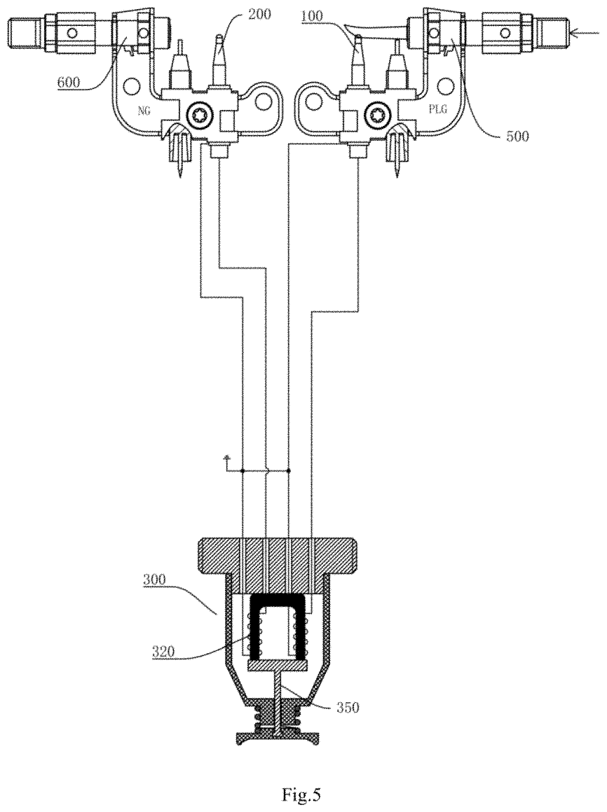

As shown in FIG. 5, the liquefied gas source is normally supplied to the liquefied gas nozzle 500, the movable member 350 is pressed, and the liquefied gas nozzle 500 is ignited normally. The ignited liquefied gas is burning at a degree that its flame can only reach the first thermocouple component 100, and does not reach the second thermocouple component 200, so that the first thermocouple component 100 generates the potential difference, while the second thermocouple component 200 does not generate the potential difference. After the magnetic fluxes of the magnetic core 320 are integrated, a magnetic force may be generated to attract the movable member 350, the electromagnetic valve is kept open, and the liquefied gas nozzle 500 keeps a normal burning state of the liquefied gas.

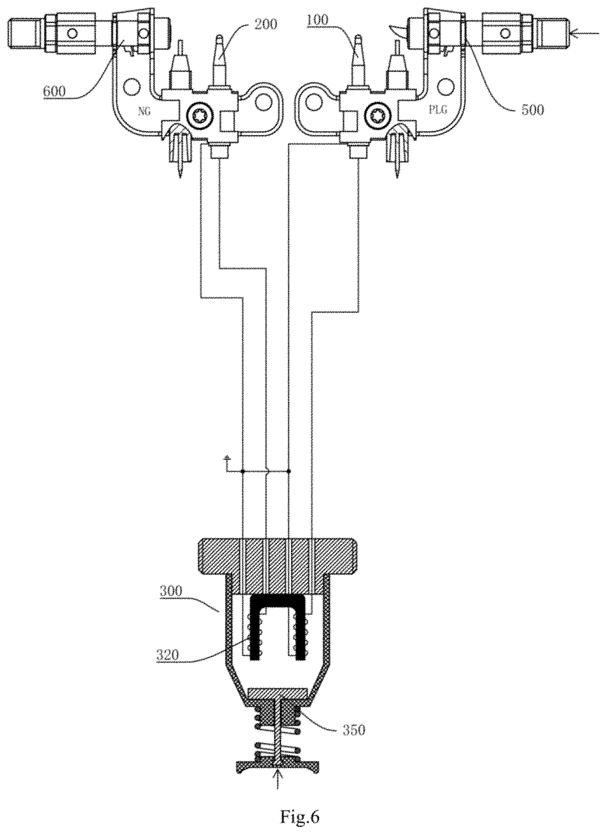

As shown in FIG. 6, when the natural gas is mistakenly connected with a liquefied gas channel, since the liquefied gas nozzle 500 has a small hole and the natural gas source has a low pressure, the ignited natural gas is burning at a low degree resulting its flame length cannot reach the first thermocouple component 100, let alone the second thermocouple component 200. The temperature is not high enough to trigger the first thermocouple component 100 to generate the potential difference. The magnetic fluxes of the magnetic core 320 after integration cannot generate the magnetic force to attract the movable member 350. After being pressed, the movable member 350 is reset by the reset member, and the electromagnetic valve is closed accordingly, so that the electromagnetic valve is closed in time when the natural gas is mistakenly connected with the liquefied gas channel.

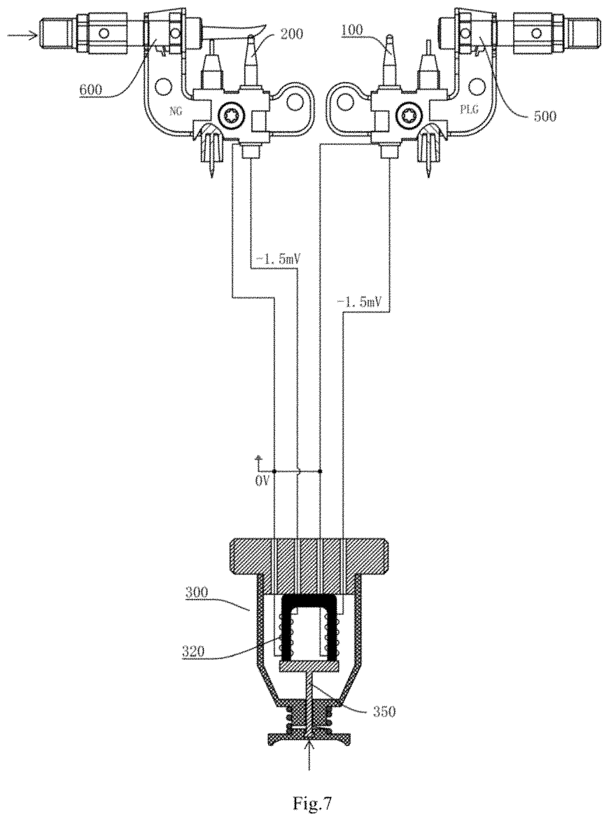

As shown in FIG. 7, the natural gas source is normally supplied to the natural gas nozzle 600, the movable member 350 is pressed, and the natural gas nozzle 600 is ignited normally. The ignited natural gas is burning at a degree that its flame can only reach the second thermocouple component 200, and does not reach the first thermocouple component 100, so that the second thermocouple component 200 generates the potential difference, while the first thermocouple component 100 does not generate the potential difference. After the magnetic fluxes of the magnetic core 320 are integrated, a magnetic force can be generated to attract the movable member 350, the electromagnetic valve is kept open, and the natural gas nozzle 600 keeps a normal burning state of the natural gas.

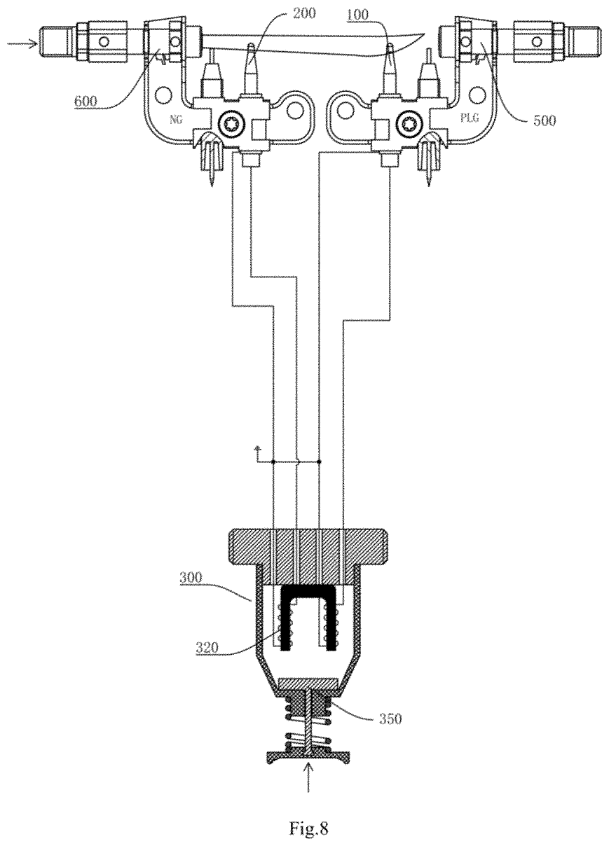

As shown in FIG. 8, when the liquefied gas is mistakenly connected with a natural gas channel, since the natural gas nozzle 600 has a large hole and the liquefied gas source has a high pressure, the ignited liquefied gas is burning at a high degree that its flame length not only reaches the second thermocouple component 200, but also reaches the first thermocouple component 100. Therefore, both the second thermocouple component 200 and the first thermocouple component 100 can be triggered to generate the potential differences. The magnetic flux generated by the magnetic core 320 driven by the first thermocouple component 100 is offset with the magnetic flux generated by the magnetic core 320 driven by the second thermocouple component 200. The magnetic fluxes of the magnetic core 320 after integration cannot generate the magnetic force to attract the movable member 350. After being pressed, the movable member 350 is reset by the reset member, and the electromagnetic valve is closed accordingly, so that the electromagnetic valve is closed in time when the liquefied gas is mistakenly connected with the natural gas channel.

Various technical features of the above embodiments may be combined randomly, and in order to make the description concise, possible combinations of various technical features in the above embodiments are not all described. However, as long as the combinations of these technical features have no contradiction, the combinations of these technical features should be considered as falling into the scope recorded by the description.

Although the embodiments of the disclosure have been shown and described, those of ordinary skills in the art may understand that various changes, modifications, substitutions and variations may be made to these embodiments without departing from the principle and purpose of the disclosure, and the scope of the disclosure is defined by the claims and their equivalents.

1. A driving device using temperature measurement, comprising:
at least two thermocouple components; and
a magnetic-drive assembly, wherein each thermocouple component is connected with the magnetic-drive assembly, the thermocouple components are capable of driving the magnetic-drive assembly to generate a magnetic flux according to an external temperature, and some of the thermocouple components drive the magnetic-drive assembly to generate a magnetic flux that is capable of being offset with a magnetic flux generated by the magnetic-drive assembly driven by the other of the thermocouple components.

2. The driving device using temperature measurement of claim 1, wherein the magnetic-drive assembly comprises a base shell, a magnetic core arranged on the base shell and a movable member movably arranged on the base shell, the movable member is attractable by a magnetic force generated by the magnetic core, electromagnetic coils matched with the thermocouple components one by one are wound on the magnetic core, and the thermocouple components are connected with the electromagnetic coils.

3. The driving device using temperature measurement of claim 2, wherein the magnetic-drive assembly further comprises a reset member arranged on the base shell, and the reset member is connected with the movable member so as to drive the movable member to reset.

4. The driving device using temperature measurement of claim 2, wherein a conductive member is arranged on the base shell, and the thermocouple components are connected with the electromagnetic coils through the conductive member.

5. The driving device using temperature measurement of claim 4, wherein the conductive member is a conductive pedestal, the conductive pedestal is connected with the base shell to form an accommodating cavity capable of accommodating the magnetic-drive assembly, the conductive pedestal is provided with at least one through hole allowing a wire to penetrate through, one pole of the thermocouple component is connected with one end of the electromagnetic coil through the wire, the other pole of the thermocouple component is connected with the conductive pedestal, and the other end of the electromagnetic coil is connected with the conductive pedestal.

6. The driving device using temperature measurement of claim 2, wherein the magnetic core comprises at least two magnetic columns, one end of each magnetic column is connected with each other, the other end of each magnetic column faces towards the movable member, and the electromagnetic coils are wound on the magnetic columns.

7. (canceled)

8. A dual-gas-source valve control system, comprising:
a first gas assembly connected with a first external gas source and capable of igniting the first gas source;
a second gas assembly connected with a second external gas source and capable of igniting the second gas source;
a first thermocouple component and a second thermocouple component both used for detecting ignition conditions of the first gas assembly and the second gas assembly in different degrees; and
a magnetic-drive assembly, wherein the first thermocouple component and the second thermocouple component are both connected with the magnetic-drive assembly, and the first thermocouple component and the second thermocouple component are both capable of driving the magnetic-drive assembly to generate a magnetic flux according to an external temperature; a magnetic flux generated by the magnetic-drive assembly driven by the first thermocouple component is capable of being offset with a magnetic flux generated by the magnetic-drive assembly driven by the second thermocouple component, the magnetic-drive assembly is driven to operate according to integration of the magnetic fluxes generated by the magnetic-drive assembly driven by the first thermocouple component and the second thermocouple component, and the operation of the magnetic-drive assembly is capable of controlling delivery of gas in the first gas assembly and the second gas assembly.

9. The dual-gas-source valve control system of claim 8, wherein the first thermocouple component and the second thermocouple component are located between an ignition end of the first gas assembly and an ignition end of the second gas assembly, the first thermocouple component is closer to the ignition end of the first gas assembly than the second thermocouple component, and the second thermocouple component is closer to the ignition end of the second gas assembly than the first thermocouple component.

10. A driving method using temperature measurement, comprising:
using a driving device using temperature measurement, the device including two thermocouple components and a magnetic-drive assembly, wherein each thermocouple component is connected with the magnetic-drive assembly, the thermocouple components are capable of driving the magnetic-drive assembly to generate a magnetic flux according to an external temperature, and some of the thermocouple components drive the magnetic-drive assembly to generate a magnetic flux that is capable of being offset with a magnetic flux generated by the magnetic-drive assembly driven by the other of the thermocouple components; and
driving, by the thermocouple components, the magnetic-drive assembly to generate magnetic fluxes according to external temperatures, and driving the magnetic-drive assembly to operate according to integration of the magnetic fluxes generated by the magnetic-drive assembly driven by all the thermocouple components.

11. The driving method using temperature measurement of claim 10, wherein the magnetic-drive assembly includes a base shell, a magnetic core arranged on the base shell and a movable member movably arranged on the base shell, the movable member is attractable by a magnetic force generated by the magnetic core, electromagnetic coils matched with the thermocouple components one by one are wound on the magnetic core, and the thermocouple components are connected with the electromagnetic coils.

12. The driving method using temperature measurement of claim 11, wherein the magnetic-drive assembly further includes a reset member arranged on the base shell, and the reset member is connected with the movable member so as to drive the movable member to reset.

13. The driving method using temperature measurement of claim 11, wherein a conductive member is arranged on the base shell, and the thermocouple components are connected with the electromagnetic coils through the conductive member.

14. The driving method using temperature measurement of claim 13, wherein the conductive member is a conductive pedestal, the conductive pedestal is connected with the base shell to form an accommodating cavity capable of accommodating the magnetic-drive assembly, the conductive pedestal is provided with at least one through hole allowing a wire to penetrate through, one pole of the thermocouple component is connected with one end of the electromagnetic coil through the wire, the other pole of the thermocouple component is connected with the conductive pedestal, and the other end of the electromagnetic coil is connected with the conductive pedestal.

15. The driving method using temperature measurement of claim 11, wherein the magnetic core includes at least two magnetic columns, one end of each magnetic column is connected with each other, the other end of each magnetic column faces towards the movable member, and the electromagnetic coils are wound on the magnetic columns.
